(19) United States
(12) Patent Application Publication
(10) Pub. No.: US 2024/0110652 A1
(43) Pub. Date: Apr. 4, 2024

(54) MATING CONNECTOR FOR CONNECTING COMPONENTS FOR LIQUID OR GASEOUS MEDIA, AND CONNECTOR ASSEMBLY AND METHOD FOR PRODUCING SUCH A MATING CONNECTOR

(71) Applicant: Henn GmbH & Co KG., Dornbirn (AT)

(72) Inventors: Manuel ROHNER, Hohenems (AT); Harald HARTMANN, Bartholomaeberg (AT)

(73) Assignee: Henn GmbH & Co KG., Dornbirn (AT)

(21) Appl. No.: 18/273,091

(22) PCT Filed: Jan. 19, 2022
(86) PCT No.: PCT/AT2022/060015

§ 371 Date: Jul. 28, 2023

(30) Foreign Application Priority Data
Jan. 20, 2021 (AT) A 50027/2021

(51) Int. Cl. F16L 37/088; B21D 22/02; B21D 28/28; F16L 37/084

(52) U.S. Cl. CPC F16L 37/0885; B21D 22/025; B21D 28/28; F16L 37/0847

(57) ABSTRACT

A mating plug connector for connecting components for liquid or gaseous media includes a connector body with: an insertion section which serves for insertion into a receiving opening of a plug connector; and a component connection which serves for connection with one of the components. The connector body is configured as a formed sheet metal part.

The invention relates to a mating plug connector for connecting components for liquid or gaseous media, as well as a plug assembly and a method for producing such a mating plug connector.

A generic plug assembly with a plug connector and with a mating plug connector is known from EP 2 360 411 A1. The plug connector for connecting pipes for liquid or gaseous media comprises a sleeve having an insertion opening. The mating plug connector can be inserted into the insertion opening. Furthermore, the plug connector comprises a latching spring which surrounds the sleeve at least over a part of its circumference and which is adjustable between a latching position for latching the mating plug connector plugged together with the plug connector and a release position latched with respect to the sleeve, in which the latching with the mating plug connector is released and the mating plug connector can be pulled out of the insertion opening of the sleeve. At least in its latching position, the latching spring projects over at least one section of its longitudinal extent, in which it can be latched to the mating plug connector, through a passage of the sleeve into the interior space surrounded by the sleeve. Furthermore, in its latched release position, the latching spring is latched at at least one latching point of the latching spring behind a retaining projection of the sleeve into a retaining recess of the sleeve. The retaining projection projects relative to the retaining recess in the axial direction of the sleeve.

The mating plug connector of EP 2 360 411 A1 is complex to manufacture.

The object of the present invention was to overcome the shortcomings of the prior art and to provide a mating plug connector which is easy to manufacture.

This object is achieved by means of a device and a method according to the claims.

According to the invention, a mating plug connector for connecting components for liquid or gaseous media is formed. The mating plug connector comprises a connector body with:
an insertion section which serves for insertion into a receiving opening of a plug connector;
a component connection which serves for connection with one of the components.

The connector body is formed as a formed sheet metal part.

The mating plug connector according to the invention has the advantage that it is easy to manufacture and also has a very low weight with sufficient strength for the intended use.

In particular, it may be provided that the connector body is formed as a deep-drawn part. In particular, a connector body formed as a deep-drawn part is easy to manufacture.

It may also be provided that the connector body is formed in one piece. A connector body formed in one piece is easy to manufacture and has a low susceptibility to defects.

In particular, it can be provided that the components to be connected are formed, for example, in the form of pipes or hoses. In this regard, the pipes can be coupled to the component connection by means of a clamping connection.

Furthermore, it is also conceivable that at least one of the components to be connected is configured, for example, as a sheet metal component. In this regard, the component connection can be welded directly to the sheet metal component. Furthermore, it is also conceivable that the connector body is press-fitted or bonded to the component. Alternatively, a combination of press-fitting and bonding is also conceivable.

Furthermore, it may be useful if the connector body has a sleeve-shaped first casing section, which in cross-section surrounds a central longitudinal axis of the connector body, and a sleeve-shaped second casing section, which in cross-section surrounds the central longitudinal axis, wherein the first casing section is surrounded by the second casing section and the first casing section is connected to the second casing section at a first longitudinal end in the region of the insertion section by a first front wall section, and wherein the second casing section has a cylindrical sealing section in the region of the insertion section. This entails the advantage that the connector body can have sufficient stability and, moreover, can have all the components for realizing the functionality of the connection with the plug connector. The cylindrical sealing section may be formed on an outer casing surface of the second casing section.

It may further be provided that, in the region of the insertion section, both the first casing section and the second casing section have a cross-sectional taper starting from the cylindrical sealing section towards the first longitudinal end of the connector body. This entails the advantage that the mating plug connector can be easily inserted into the plug connector. Furthermore, the taper can further increase the stability of the connector body.

In addition, it may be provided that the second casing section has a cross-sectional enlargement on the side of the cylindrical sealing section facing away from the first front wall section and adjoining the cylindrical sealing section. This entails the advantage that the latching spring can be pressed on by the cross-sectional enlargement and thus the joining of the mating plug connector to the plug connector can be simplified.

Also advantageous is an embodiment according to which it can be provided that the second casing section has a contact surface for a locking element of the plug connector on the side facing away from the cylindrical sealing section at a distance from the cross-sectional enlargement. This entails the advantage that by this measure the locking element can well secure the mating plug connector in the plug connector.

According to an advancement, it is possible that the contact surface is formed circumferentially and forms a second longitudinal end of the second casing section. A contact surface formed in this way is easy to manufacture and can also have sufficient stability.

In an alternative embodiment variant, it can be provided that a locking slot is formed in which the contact surface is arranged, wherein the locking slot penetrates the second casing section, in particular the cylinder section, and extends over a circumferential region of the second casing section. This entails the advantage that such a locking slot is easy to manufacture.

Furthermore, it may be provided that a tab is formed which is bent outwardly from the second casing section, wherein the tab extends over a circumferential area of the second casing section and wherein the tab extends over a longitudinal area of the second casing section. Such a tab may simply serve as an anti-rotation device.

Further, it may be provided that the second casing section has an outwardly curved collar in the region of a second longitudinal end. This entails the advantage that such an outwardly bent collar can serve as an axial stop. Furthermore, the outwardly bent collar can provide increased stability to the connector body.

According to a particular embodiment, it is possible for the first casing section to have a taper at a second longitudinal end. This entails the advantage that the mating plug connector can be easily joined to a pipe.

The invention further relates to a plug assembly comprising:
a mating plug connector;
a plug connector having a receiving opening, wherein the receiving opening is configured such that the mating plug connector is insertable therein.

The mating plug connector is formed according to the statements above.

A plug assembly formed in this manner exhibits ease of manufacture.

According to the invention, a method for manufacturing a mating plug connector is provided.

The method comprises the method steps:
providing a flat metal sheet;
pulling a cup from the flat metal sheet;
inverting the cup to form a sleeve-shaped first casing section surrounding, in cross-section, a central longitudinal axis of the plug connector and a sleeve-shaped second casing section surrounding, in cross-section, the central longitudinal axis, wherein the first casing section is surrounded by the second casing section and the first casing section is connected to the second casing section at a first longitudinal end in the region of the insertion section by a first front wall section, and wherein the second casing section has a cylindrical sealing section in the region of an insertion section.

The method according to the invention has the advantage that a mating plug connector can be easily manufactured by the method and, in addition, has a very low weight with sufficient strength for the intended use.

Furthermore, it may be provided that a locking slot is punched in the cup after the cup has been pulled. By this measure, the locking slot can be easily produced.

Furthermore, it may be provided that after the cup was inverted, a tab is bent outwardly from the second casing section, wherein the tab extends over a circumferential area of the second casing section and wherein the tab extends over a longitudinal area of the second casing section. By this measure, a tab which serves as an anti-rotation device can be easily manufactured.

Advantageously, there is also an embodiment according to which it can be provided that, after the cup has been inverted, a central hole is punched out of the cup. This measure enables fluid permeability of the mating plug connector to be achieved by removing the base created during production.

For the purpose of better understanding of the invention, it will be elucidated in more detail by means of the figures below.

These show in a respectively very simplified schematic representation:

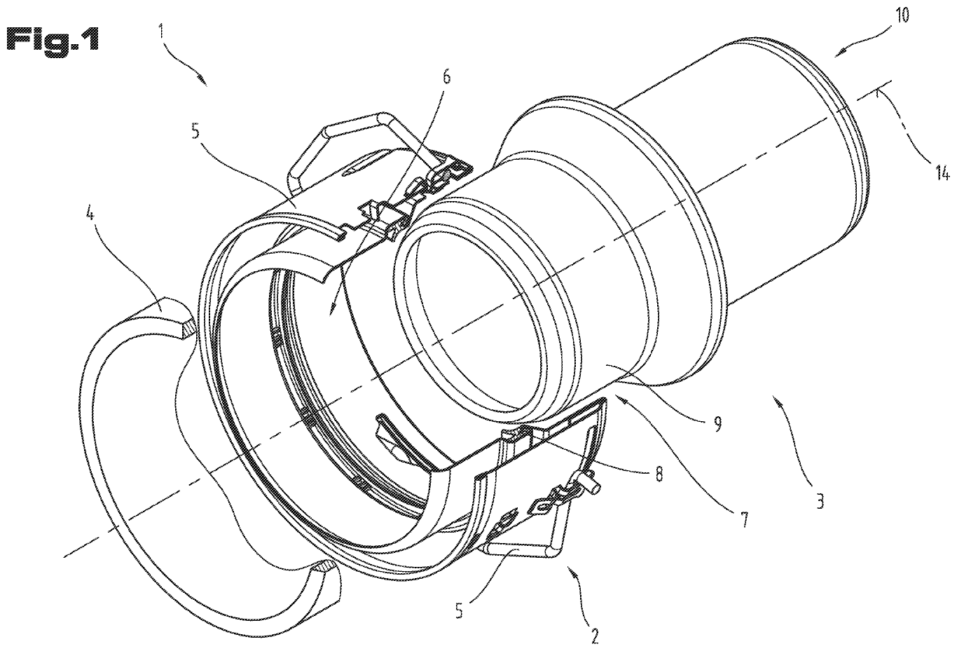

FIG. 1 a perspective view of an embodiment variant of a plug assembly in a quarter section;

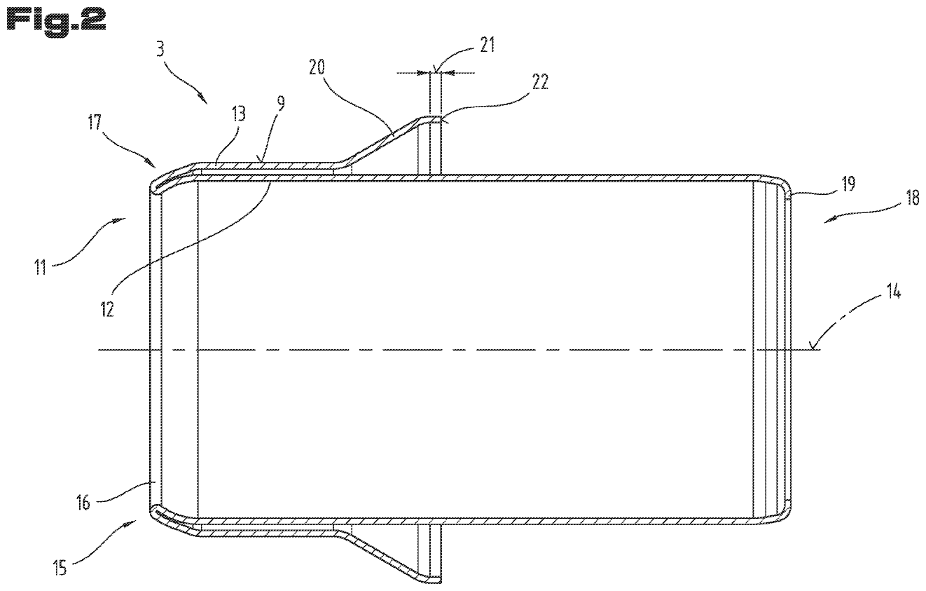

FIG. 2 a longitudinal section of a first exemplary embodiment of a mating plug connector;

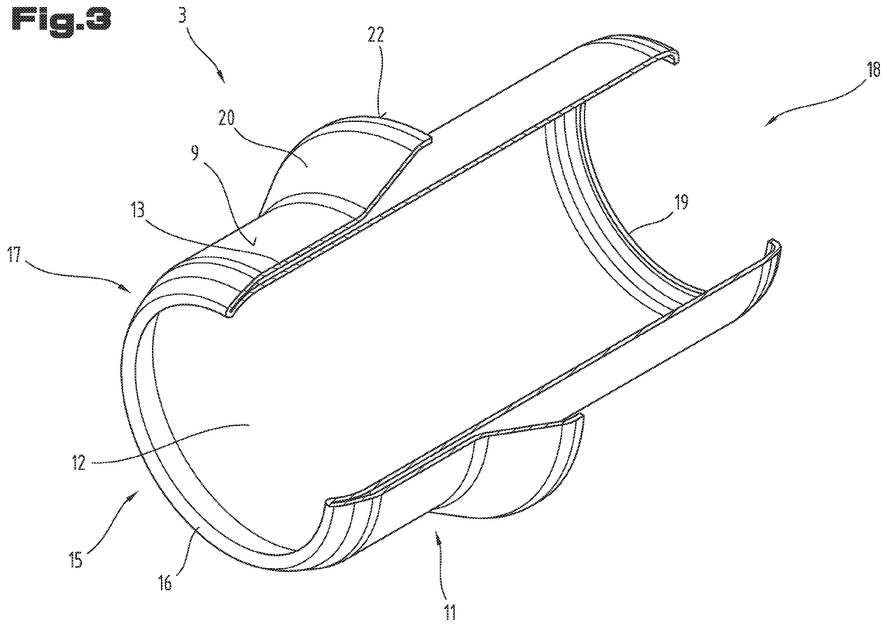

FIG. 3 a perspective view of a quarter section of the first exemplary embodiment of the mating plug connector;

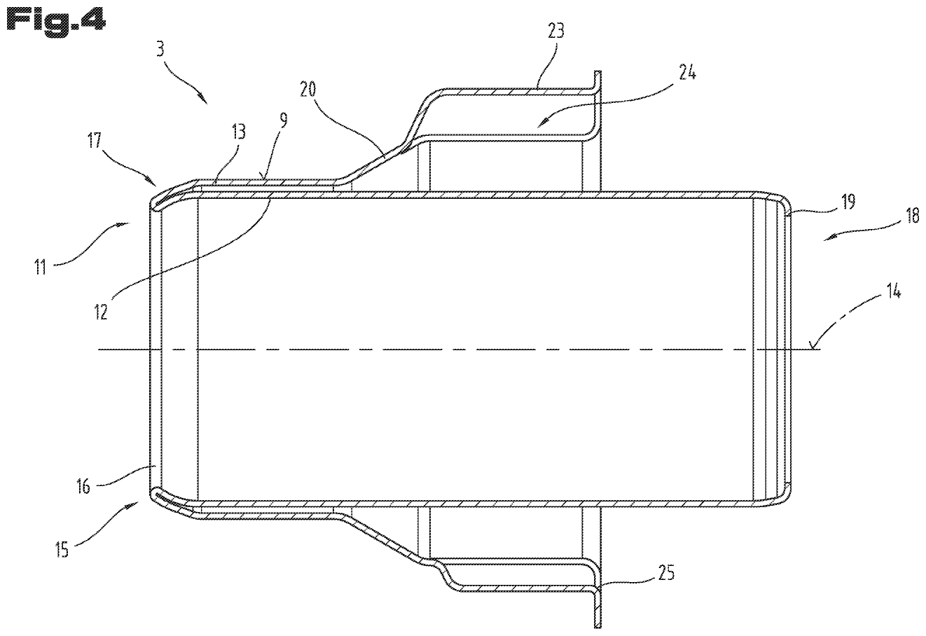

FIG. 4 a longitudinal section of a second exemplary embodiment of a mating plug connector;

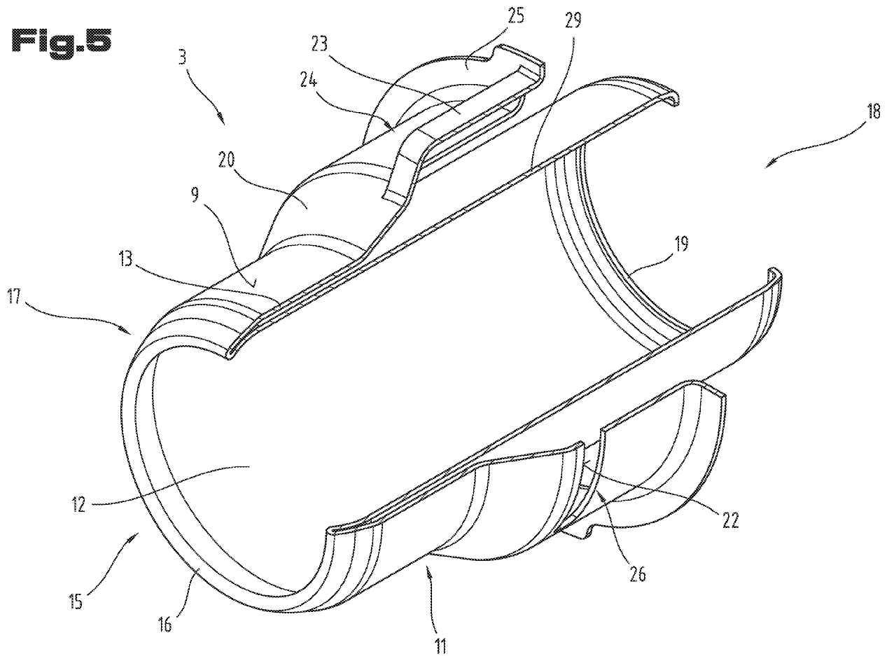

FIG. 5 a perspective view of a quarter section of the second exemplary embodiment of the mating plug connector;

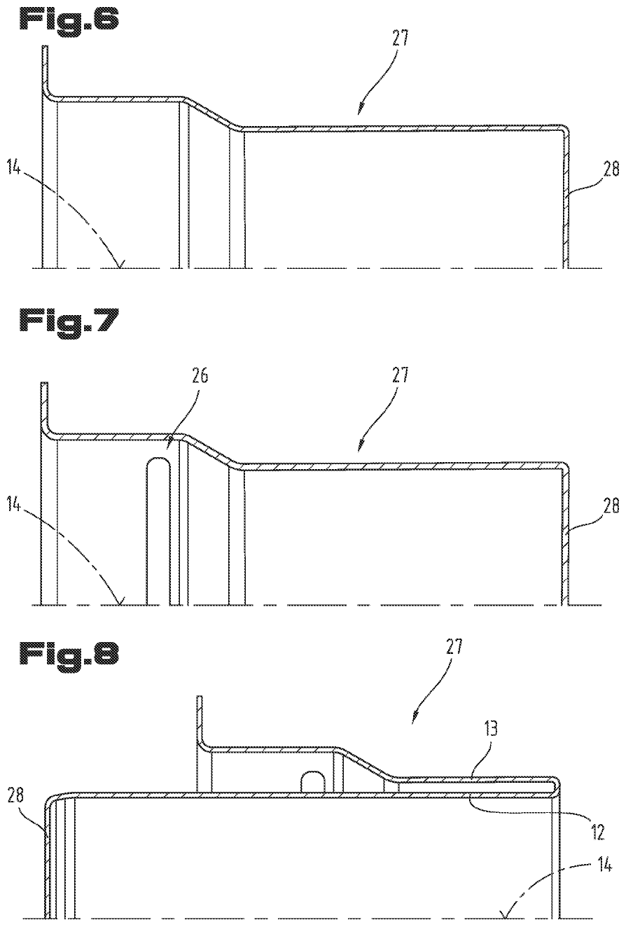

FIG. 6 a first method step for producing the second exemplary embodiment of the mating plug connector;

FIG. 7 a second method step for producing the second exemplary embodiment of the mating plug connector;

FIG. 8 a third method step for producing the second exemplary embodiment of the mating plug connector;

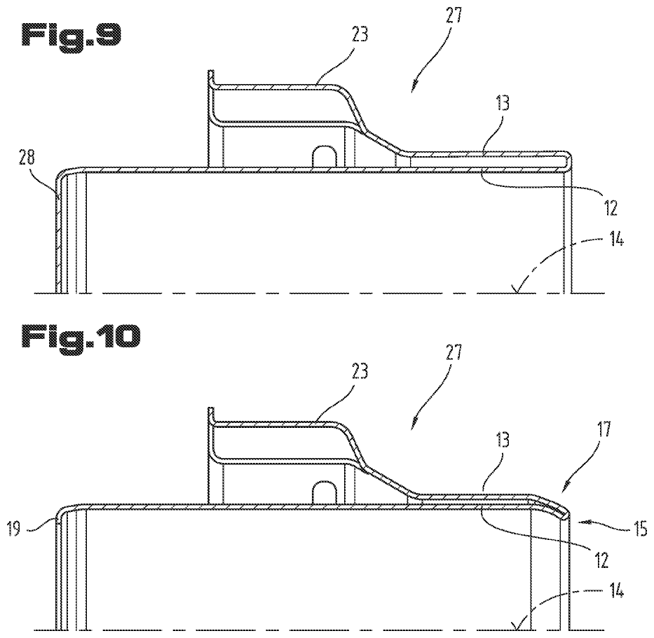

FIG. 9 a fourth method step for producing the second exemplary embodiment of the mating plug connector;

FIG. 10 a fifth method step for producing the second exemplary embodiment of the mating plug connector.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a perspective view of a plug assembly 1 with a plug connector 2, wherein it is represented in a quarter section. FIG. 1 further schematically represents a mating plug connector 3, which can be connected to the plug connector 2. The interoperation between the plug connector 2 and the mating plug connector 3 is sufficiently described in AT 509 196 B1.

Moreover, a tube 4 is schematically shown, to which the plug connector 2 may be coupled. The tube 4 may, for example, be a rigid element, such as a plastic tube. In a different embodiment variant, the tube 4 may be formed as a flexible pipe made of a rubber material.

The plug connector 2 comprises a main body, which is preferably formed as a one-piece formed part, for example a deep drawing part, in particular of a stainless steel sheet. In particular, it can also be provided that this can be a coated steel sheet or also a production from steel sheet which is subsequently coated.

The plug assembly 1 is preferably used in a vehicle, in particular in a road-bound power-driven vehicle having a combustion engine, such as a car or a truck.

Of course, it is also conceivable that the plug assembly 1 is used in another application having a combustion engine. This could be, for example, the use of the plug assembly 1 in a stationary power unit, in a marine engine, in an aircraft engine, in a construction machine, in battery- or hybrid-powered vehicles, etc.

In particular, the plug assembly 1 may be used for connecting different components of the fresh air supply means to the combustion engine. It can for example be provided that the plug connector 2 with the corresponding mating plug connector 3 is provided for connecting two parts in the intake area of a turbocharger. It can further also be provided, for example, that such a plug assembly 1 is used for connecting two components on the pressure side leaving the turbocharger. In yet another application, it is also conceivable that the plug assembly is used to connect a water-carrying pipe.

As can further be seen from FIG. 1, it can be provided that the plug connector 2 has a receiving opening 6 which serves to receive an insertion section 7 of the mating plug connector 3. A seal 8 can be arranged in the region of the receiving opening 6, which serves to produce a sealed connection between the plug connector 2 and the mating plug connector 3. In particular, it can be provided that in the mated state of the plug connector 2 and the mating plug connector 3, the seal 8, which is arranged in the receiving opening 6, rests against a cylindrical sealing section 9 of the mating plug connector 3.

As can further be seen from FIG. 1, the mating plug connector 3 can be provided with a component connection 10 which serves to connect a fluid-carrying or gas-carrying component. For the sake of simplicity, the fluid-carrying or gas-carrying component is not shown here.

As can be seen from FIG. 1, a locking element 5 can be provided that can be activated and deactivated so that the plug connector 2 and the mating plug connector 3 can be separated from and/or connected to each other as required. The locking element 5 may be brought into a latching position, in which the plug connector 2 and the mating plug connector 3 are secured relative to one another. Moreover, the locking element 5 may be brought into a release position, in which the mating plug connector 3 can be inserted into the plug connector 2 or removed therefrom. In particular, it may be provided that the locking element 5 is configured in the form of a latching spring.

FIG. 2 shows a longitudinal section of a first exemplary embodiment of the mating plug connector 3. FIG. 3 shows the first exemplary embodiment of the mating plug connector 3 in a perspective representation of a quarter section.

The first exemplary embodiment of the mating plug connector 3 is described using a combination of FIGS. 2 and 3.

As can be seen in FIG. 2, it may be provided that the mating plug connector 3 is configured as a formed sheet metal part. Furthermore, it is also conceivable that the mating plug 3 is configured as an injection-molded plastic part. In particular, it may be provided that the mating plug connector 3 comprises a connector body 11. The connector body 11 may comprise a first casing section 12 and a second casing section 13. The two casing sections 12, 13, at least in their basic form, can be rotationally symmetrical with respect to a central longitudinal axis 14 of the connector body 11.

As further shown in FIG. 2, it may be provided that the first casing section 12 and the second casing section 13 are coupled to each other at a first longitudinal end 15 of the connector body 11 by means of a first front wall section 16. In particular, it may be provided that the first casing section 12 and the second casing section 13 and the first front wall section 16 are formed from a one-piece continuous sheet. In particular, it may be provided that, viewed in longitudinal section, in the region of the first front wall section 16 the sheet is folded over by 180° and merges from the first casing section 12 into the second casing section 13.

As can be further seen from FIG. 2, it can be provided that the first casing section 12 and the second casing section 13 have a cross-sectional taper 17 in the region of the first longitudinal end 15. The first casing section 12 may have a cylindrical shape subsequent to the cross-sectional taper 17. As further shown in FIG. 2, it may be provided that the first casing section 12 has a taper 19 at a second longitudinal end 18 of the first casing section 12. In particular, the taper 19 may be in the form of a collar extending 90° inwardly from the cylindrical section of the first casing section 12.

As further shown in FIG. 2, it may be provided that the second casing section 13 has the cylindrical sealing section 9 adjoining the cross-sectional taper 17. Adjoining the cylindrical sealing section 9, a cross-sectional enlargement 20 may be formed. A contact surface 22 for contacting the locking element 5 may be formed at a distance 21 from the cross-sectional enlargement 20. As can be seen from FIG. 2, it can be provided that the contact surface 22 is formed in that the second casing section 13 ends here.

FIG. 4 shows a longitudinal section of a second exemplary embodiment of the mating plug connector 3. FIG. 5 shows the second exemplary embodiment of the mating plug connector 3 in a perspective view of a quarter section.

FIGS. 4 and 5 show a further and possibly independent embodiment of the mating plug connector 3, wherein again equal reference numbers and/or component designations are used for equal parts as in the preceding FIGS. 2 and 3. In order to avoid unnecessary repetitions, it is pointed to/reference is made to the detailed description in FIGS. 2 and 3 preceding it.

As can be seen in FIG. 4, it can be provided that a tab 23, which is bent outwards from the second casing section 13, is formed in the second casing section 13. The tab 23 can serve as an anti-rotation device.

As can be seen from FIG. 5, the tab 23 can have a limited extension over a circumferential region of the second casing section 13 and/or over a longitudinal region of the second casing section 13. In particular, it may be provided that the tab 23 is arranged in a cylinder section 24.

As can be further seen from FIG. 4, it can be provided that a collar 25, which projects outwardly relative to the cylinder section 24, is formed adjacent to the cylinder section 24. The collar 25 can be configured to be circumferential.

As can be seen from FIG. 5, it can be provided that a locking slot 26, which serves to form the contact surface 22, is formed in the cylinder section 24 of the second casing section 13. The locking slot 26 can also have a limited longitudinal extension and/or a limited circumferential extension.

As can be seen from FIG. 5, it can be provided that a plurality of locking slots 26 are formed in the second casing section 13, spaced apart from one another in the circumferential direction. Furthermore, it may be provided that multiple tabs 23 are formed on the second casing section 13 spaced apart from one another in the circumferential direction.

In particular, it may be provided that two tabs 23 are formed 180° opposite each other in the second casing section 13.

In particular, it may be provided that two locking slots 26 are arranged 180° opposite each other in the second casing section 13.

FIGS. 6 to 10 show individual method steps for producing the second exemplary embodiment of the mating plug connector 3.

In particular, the complete external part of the connector body 11 is referred to as the second casing section 13. As can be seen from FIG. 5, it can be provided that the second casing section 13, starting from the first longitudinal end 15, is divided into the following areas: cross-sectional taper 17, cylindrical sealing section 9, cross-sectional enlargement 20, cylindrical section 24, collar 25.

In the first exemplary embodiment according to FIG. 2 and FIG. 3, the cylinder section 24 has only a very short length.

In particular, the complete internal part of the connector body 11 is referred to as the first casing section 12. As can be seen from FIG. 5, it can be provided that the first casing section 12, starting from the first longitudinal end 15, is divided into the following areas: Cross-sectional taper 17, main part 29 of the first casing section 12, taper 19.

The individual areas of the first casing section 12 may look the same and be designated the same in all exemplary embodiments.

FIG. 6 shows a first method step for producing the second exemplary embodiment of the mating plug connector 3. As can be seen from FIG. 6, it may be provided that a cup 27 is drawn from the flat sheet metal blank in the first method step. The cup 27 may have a base 28 due to the manufacturing process.

In a second method step, as shown in FIG. 7, it can be provided that a locking slot 26 is punched out of the cup 27.

As shown in FIG. 8, it can be provided that in a third method step the base 28 of the cup 27 is inverted and/or pulled through inwardly so that the first casing section 12 and the second casing section 13 are formed.

At this point, it should be noted that the dimensional relationships in the individual FIGS. 6 to 10 are not to scale, but rather a lengthening and/or shortening of the axial extension of certain sections of the mating plug connector 3 has been made for the sake of clearer presentation.

As can be seen from FIG. 9, it can be provided that in the fourth method step the tab 23 is punched and/or bent outwardly from the second casing section 13.

As shown in FIG. 10, it can be provided that in the fifth method step, both the first casing section 15 and the second casing section 13 are bent inwards in the region of the first longitudinal end 12, so that the cross-sectional taper 17 is formed.

In a further process step, which is also shown in FIG. 10, the base 28 can be punched out so that the taper 19 is formed.

The method steps for producing the first exemplary embodiment of the mating plug connector 3 are similar to the method steps illustrated and described in FIGS. 6 to 10. Since the first exemplary embodiment of the mating plug connector 3 is simpler to manufacture and individual method steps are omitted here compared to the process described, this manufacturing process is not described separately and/or shown in the figures. In particular, the method steps according to FIG. 7 for punching out the locking slot 26 and the method step according to FIG. 9 for producing the tab 23 are not carried out and/or omitted for producing the first exemplary embodiment.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10. Finally, as a matter of form, it should be noted that for ease of understanding of the structure, elements are partially not depicted to scale and/or are enlarged and/or are reduced in size.

### LIST OF REFERENCE NUMBERS

1 Plug assembly
2 Plug connector
3 Mating plug connector
4 Tube
5 Locking element
6 Receiving opening
7 Insertion section
8 Seal
9 Cylindrical sealing section
10 Component connection
11 Connector body
12 First casing section
13 Second casing section
14 Longitudinal axis
15 First longitudinal end
16 First front wall section
17 Cross-sectional taper
18 Second longitudinal end
19 Taper
20 Cross-sectional enlargement
21 Distance
22 Contact surface
23 Tab
24 Cylinder section
25 Collar
26 Locking slot
27 Cup
28 Base
29 Main part

1. A mating plug connector (3) for connecting components for liquid or gaseous media, comprising a connector body (11) with:
an insertion section (7) which serves for insertion into a receiving opening (6) of a plug connector (2);
a component connection (10) which serves for connection with one of the components, wherein
the connector body (11) is configured as a formed sheet metal part.

2. The mating plug connector (3) according to claim 1, wherein the connector body (11) has a sleeve-shaped first casing section (12), which in cross-section surrounds a central longitudinal axis (14) of the connector body (11), and a sleeve-shaped second casing section (13), which in cross-section surrounds the central longitudinal axis (14), wherein the first casing section (12) is surrounded by the second casing section (13) and the first casing section (12) is connected to the second casing section (13) at a first longitudinal end (15) in the region of the insertion section (7) by a first front wall section (16), and wherein the second casing section (13) has a cylindrical sealing section (9) in the region of the insertion section (7).

3. The mating plug connector (3) according to claim 2, wherein, in the region of the insertion section (7), both the first casing section (12) and the second casing section (13) have a cross-sectional taper (17) starting from the cylindrical sealing section (9) towards the first longitudinal end (15) of the connector body (11).

4. The mating plug connector (3) according to claim 2, wherein the second casing section (13) has a cross-sectional enlargement (20) on the side of the cylindrical sealing section (9) facing away from the first front wall section (16) and adjoining the cylindrical sealing section (9).

5. The mating plug connector (3) according to claim 4, wherein the second casing section (13) has a contact surface (22) for a locking element of the plug connector on the side facing away from the cylindrical sealing section (9) at a distance (21) from the cross-sectional enlargement (20).

6. The mating plug connector (3) according to claim 5, wherein the contact surface (22) is formed circumferentially and forms a second longitudinal end (18) of the second casing section (13).

7. The mating plug connector (3) according to claim 5, wherein a locking slot (26) is formed in which the contact surface (22) is arranged, wherein the locking slot (26) penetrates the second casing section (13), in particular the cylinder section (24), and extends over a circumferential region of the second casing section (13).

8. The mating plug connector (3) according to claim 2, wherein at least one tab (23) is formed which is bent outwardly from the second casing section (13), wherein the tab (23) extends over a circumferential area of the second casing section (13) and wherein the tab (23) extends over a longitudinal area of the second casing section (13).

9. The mating plug connector (3) according to claim 2, wherein the second casing section (13) has an outwardly curved collar (25) in the region of a second longitudinal end (18).

10. The mating plug connector (3) according to claim 1, wherein the first casing section (12) comprises a taper (19) at a second longitudinal end (18).

11. A plug assembly (1) comprising:
a mating plug connector (3);
a plug connector (2) having a receiving opening (6), wherein the receiving opening (6) is configured such that the mating plug connector (3) is insertable therein, wherein
the mating plug connector (3) is configured according to claim 1.

12. A method for producing a mating plug connector (3), comprising the method steps:
providing a flat metal sheet;
pulling a cup (27) from the flat metal sheet;
inverting the cup (27) to form a sleeve-shaped connector body (11) with a first casing section (12), which in cross-section surrounds a central longitudinal axis (14) of the connector body (11), and a sleeve-shaped second casing section (13), which in cross-section surrounds the central longitudinal axis (14), wherein the first casing section (12) is surrounded by the second casing section (13) and the first casing section (12) is connected to the second casing section (13) at a first longitudinal end (15) in the region of the insertion section (7) by a first front wall section (16), and wherein the second casing section (13) has a cylindrical sealing section (9) in the region of the insertion section (7).

13. The method according to claim 12, wherein a locking slot (26) is punched in the cup (27) after the cup (27) has been pulled.

14. The method according to claim 12 or 13, wherein after the cup (27) was inverted, at least one tab (23) is bent outwardly from the second casing section (13), wherein the tab (23) extends over a circumferential area of the second casing section (13) and wherein the tab (23) extends over a longitudinal area of the second casing section (13).

15. The method according to claim 12, wherein after the cup (27) was inverted, a central hole is punched out of the cup (27).
